(19) United States
(12) Patent Application Publication
(10) Pub. No.: US 2018/0168393 A1
(43) Pub. Date: Jun. 21, 2018

(54) PROCESS FOR COOKING FOOD PRODUCTS

(71) Applicant: Convotherm-Elektrogeräte GmbH, Eglfing (DE)

(72) Inventor: Michael Schilling, Peißenberg (DE)

(21) Appl. No.: 15/847,074

(22) Filed: Dec. 19, 2017

(30) Foreign Application Priority Data
Dec. 20, 2016 (DE) 102016225612.2

(51) Int. Cl. A47J 36/00; A23L 5/10; A47J 27/00

(52) U.S. Cl. CPC A47J 36/00; A23V 2002/00; A47J 27/002; A23L 5/10

(57) ABSTRACT

A method for cooking food products with matching cooking characteristics, which comprises the following process steps: determining or entering of at least one critical cooking state of at least one cooking product from the totality of the cooking products to be cooked; starting of the cooking process of all food products; indicating of the attainment of the critical cooking state determined and/or entered and its duration; and preventing of an interruption of the critical cooking state, wherein a selection of new cooking processes is reserved and automatically recorded as a product waiting list and preferably indicated at the end of the critical cooking state and its duration.

### BACKGROUND

### 1. Field of the Disclosure

The present disclosure involves the creation of a method for the cooking of cooking products that enables the correct cooking of cooking goods which have a critical cooking state in a simple and reliable manner as well. In particular, that applies to the parallel cooking of several and additionally different cooking products with loading and unloading times that differ as well.

### 2. Discussion of the Background Art

Various processes for cooking food products are set forth in DE 10 2011 109 398 A1, DE 10 2011 000 291 A1, DE 10 2014 103 480 A1 and DE 10 2010 037 388 A1 which are incorporated herein by reference thereto.

Tests carried out in the scope of the disclosure showed that a large number of cooking products have different cooking characteristics which comprise a critical cooking state in particular. For example, a critical cooking state can be a period of time at a certain temperature and/or a certain degree of moisture which is necessary for the perfect preparation of the respective cooking goods. As an example of that, we can specify the cooking of buns (bread rolls), which require exposure to a certain temperature without interruption at the end of their cooking process in order to be able to achieve the desired colouring and the crispy state of their topside.

If this critical cooking state is not adhered to, the respective cooking goods may even get damaged to a degree that they have to be disposed of.

### SUMMARY

Specifically, a method for the cooking of cooking products which have different cooking characteristics is created, which comprises the following process steps:

At first, the cooking products to be cooked are placed in the cooking chamber of a cooking device.

After that, either at least one critical cooking state of at least one cooking product of the totality of the cooking products to be cooked is determined, or the critical cooking state is entered in the cooking device, for example by means of a suitable input unit with indicator and input keyboard.

In the subsequent process step, the cooking process of all cooking products is started, whereby these can be one or several cooking product(s). Then the attainment of the critical cooking state determined and/or entered and its duration are indicated and finally an interruption of the critical cooking state is prevented. Here, the indication of the attainment of the critical cooking state determined and/or entered and its duration is an optional measure of a particularly preferred embodiment of the method according to the disclosure, which also manages without the indication of the critical cooking state or states on principle because an interruption of the critical cooking state, also for example a certain time span during which a certain treatment of the respective cooking product is required, will be prevented at any rate even if such an indication is dispensed with.

Finally, it is provided according to the disclosure that some kind of waiting list is indicated for products, which at the end of the critical cooking state and its duration automatically indicates the type of products that were requested, for example by an operator, but rejected because of the continuation of the critical cooking state. This means that it is possible to indicate that, for example after an inquiry by an operator whether a new cooking product can be introduced in the cooking chamber, the device blocks this loading on the one hand because of the continuation of the critical cooking state, but stores and indicates the product requested or informs the user acoustically and/or visually that a product, which is, at the end of the critical cooking state and the unloading of the fully cooked cooking products, now available for a new cooking process, or that this new product could be loaded and started with a single door opening during the unloading of the cooking product or products with a critical cooking state at the end of their cooking process.

Accordingly, it can be indicated visually or acoustically or visually as well as acoustically.

A particularly preferred measure for preventing an interruption of the critical cooking state is the blocking of the access to the cooking products to be cooked, for example by means of a locking of the cooking chamber door of a cooking device in which the method according to the disclosure is implemented.

As an alternative to the blocking of the access to the cooking products to be cooked, it is also possible to prevent the interruption of the critical cooking state by means of a blocking of the selection option on an indicator and/or input device of the cooking device where the cooking products to be cooked are being processed. Here, the blocking of the selection option means that the cooking device indicates that further cooking products which are not in the cooking chamber yet, which on principle could be introduced in the cooking chamber, must not be introduced in the cooling chamber because of the attainment of the critical cooking state and, for example, how long this blocking will take in addition.

According to the disclosure, the determination of the critical cooking state can either be carried out automatically or manually, or automatically as well as manually.

Here, the manual determination is for example the input of a time span for the critical cooking state, such as with bread rolls, an end phase of 3 minutes with a total cooking duration of 30 minutes. A partly manual determination can be carried out by entering a percentage, such as 5%, as a default value for all recipes stored in the cooking device, whereby the cooking device determines, depending on the cooking recipe, the actual length of time based on the total duration of the respective recipes stored so that different time values can be the result of this partly manual determination for the critical cooking state. In this connection, it has to be emphasized that the critical cooking state is not always just the end phase of a cooking process, but can also very well start and end again at other times and also multiple times during the sequence of a cooking process.

An automatic determination which is carried out by the cooking device and can be provided for in the cooking device by means of suitable programming based on standard cooking parameters, such as temperature, cooking time, moisture, loading quantity, cooking characteristics, type of cooking goods, size of cooking goods, weight of cooking goods or required core temperature to be reached, can automatically determine the critical cooking state, its start, its duration and thus its end. The indication of further cooking products matching the cooking products already inside the cooking device and the blinding out of recipes which do not fit the cooking products that are already inside the cooking chamber, respectively, can be realised according to the principles of EP 1 798 479 B2, the disclosure of which is herewith fully made disclosure content of the application in hand by means of reference.

The disclosure furthermore concerns a method for the cooking of cooking products with matching cooking characteristics in which it is determined even before a loading of the cooking device whether cooking products selected for loading have a critical cooking state and the selected cooking products do not exclude each other and are also compatible with any cooking products that may already be inside the cooking device.

As the first process step, this method has the selection of cooking products which are to be placed and cooked in the cooking chamber of a cooking device. Such a selection can be carried out on the device, for example, by activating cooking programme buttons according to the cooking products.

After this selection step, it is determined whether the selected cooking products have a critical cooking state, preferably on the device side and automatically.

If that is the case, it is determined whether in case that the selected cooking products are added to the cooking process, there will be no interruption of all cooking products cooking or to be cooked in the cooking device in their critical ranges, if applicable (e.g. by opening the door during unloading of one of the products/i.e. a newly added cooking product and/or one already inside the cooking device ends in the critical range of a further cooking product. Another example of an interruption is the loading of further ingredients and sauces, respectively, during a cooking process by defining an announcement step for which the door needs to be opened).

If it is determined that there can be no interruption of the critical cooking states during the cooking process of the selected cooking products, the loading of the cooking device with the selected cooking products is enabled, whereby the respective cooking process or processes can be started after the loading has been completed.

In other words, this means that when an interruption is found, a loading is indicated as inadmissible in the first place, or can be prevented in the first place, for example by means of locking the cooking chamber door.

As an alternative to that, it would be possible to prevent, in case of a deliberate loading despite an indication stating that a loading is inadmissible due to an interruption of the critical cooking states, the start of the cooking process or processes, whereby it is possible in a preferable manner in that case that the inadmissible loading is reported to a monitoring point in order to enable the taking of further countermeasures as required.

Another embodiment comprises the process step to determine whether cooking products have already been placed in the cooking device.

In that case, a selection of at least one or several further cooking products still to be loaded which, in comparison with a time of loading of the first cooking goods, is to be carried out at a later point in time can be carried out.

In a further process step, it is determined for that purpose whether there will be an interruption of the critical cooking state or states of the cooking good or goods already inside the cooking chamber due to the critical cooking states of the further cooking product or products to be loaded subsequently.

The subsequent loading will only be enabled in the event that this step of determination shows that there will be no interruption and no overlap, respectively.

Overlapping may be permissible if the unloading time of one of the cooking products is not within another critical range. An overlap will be problematic if the critical ranges are at the end of the cooking process and were therefore completed before an unloading! Example: cooking product 1 has its critical phase from minute 1 to minute 2 within the recipe, which takes 5 minutes in total. Cooking product 2 has its critical phase from minutes 1:30 to 2:30 within the recipe, which takes 6 minutes in total. These two products can be started at the same time. The critical phases overlap, but there will be no unloading or, put in general terms, a door opening or none will be carried out because these are in the middles of the recipes. The situation becomes critical if one product 3 is cooked in parallel with 1 and 2 and its cooking time is only 1:45. The unloading of it falls in the critical range of cooking product 1 as well as of cooking product 2. Such a constellation would be inadmissible

Constellations where 2 different cooking products are started at the same time, whereby one of the two (without its own critical range—this without any overlap!) ends in the critical range of the other, are also inadmissible. Here, only one of the products has a critical range, but it is interrupted by the unloading of the other, which has no critical range itself.

With this particularly preferred embodiment as well, it is possible in case of an inadmissible arbitrary subsequent loading to prevent the start of the cooking programme or to prevent access to the cooking chamber by locking the cooking chamber door. An announcement to a monitoring point is also conceivable with this design.

When it is determined whether there is an interruption of critical cooking states or whether there is no interruption, the following parameters can be considered with the two particularly preferred embodiments of the method according to the disclosure described above:
Type of cooking products,
Quantity of cooking products,
Time offset between the time of first loading and a subsequent loading,
Compensation values, such as door compensation, extension of cooking time,
Cooking space position, in particular cooking space level in the cooking chamber of the cooking device,
Unloading times,
Times of announcement steps with user interactions (door opening!), and
Fan speed.

Furthermore, the disclosure concerns a cooking device which is designed as a commercial cooking device in particular.

The cooking device according to the disclosure has a cooking chamber which can be opened and closed by means of a cooking chamber door and where cooking products can be introduced on cooking goods carriers, on levels arranged one on top of the other, for example. Naturally, the cooking device according to the disclosure also has all other usual components, such as heater, fan wheel, cleaning equipment, etc., which do not have to be described in detail for the explanation of the principles according to the disclosure, however.

Optionally, the cooking device according to the disclosure can also comprise a detection device, such as a product scanner in the form of a camera or other suitable sensors, for the detection of products to be cooked that are introduced in the cooking chamber.

Furthermore, the cooking device according to the disclosure can comprise a control device and an input device with an indication for the automatic and/or manual and/or partly manual determination of the critical cooking state of at least one of the products to be cooked or the entering of this critical cooking state, whereby the control device can be in an operative connection/signal connection with the detection device. Finally, the cooking device according to the disclosure has an indicator device by which the critical cooking state and its duration can be indicated, whereby this indicator device is an optional characteristic, i.e. does not need to be provided obligatorily. The indicator device can output a visual indication signal, an acoustic indication signal or a visual as well as an acoustic indication signal, and with a particularly preferred embodiment, can be set up to present a limited product selection option.

In a further particularly preferred embodiment, the control device may be in an operative connection/signal connection with a cooking chamber locking device which blocks the opening of the cooking chamber door for the duration of the critical cooking state. Such a cooking chamber locking device can be, for example, a retractable and extendable door lock which is, for example, mechanically moved in the locking position of the cooking chamber door when the critical cooking state commences, and releases that locking position again when it is found that the duration of the critical cooking state has passed.

As explained above, the critical cooking state can be entered manually in the cooking device, for example by an operator, simply based on the awareness of an existence of such a critical cooking state, at the start of a cooking process, and that regarding its commencement and its duration.

Alternatively, when you are aware of such critical cooking states, it is possible to program the respective cooking programmes/recipes including consideration of such a critical cooking state or also a majority of such critical cooking states during the sequence of a cooking programme. If there are several critical cooking states during the sequence of a cooking programme, these could naturally also be entered manually by an operator before the start and/or during the programme sequence of the respective cooking programme on principle.

As an alternative, the manufacturer can already store suitable critical cooking states in the collection of cooking programmes (cookbook).

It is also conceivable that when interruptions in critical ranges of cooking products are found, to have the cooking product combination entered of the device optimised manually by the user or automatically by the cooking device in order to avoid the existing interruptions. An optimisation could define, for example, that a cooking product is to be added only a little later (that will then be pointed out to the user acoustically or visually), for example in order to achieve a postponement of an interruption (e.g. by opening the door for unloading at the end of the cooking process of a product). In that way, a product would be started a little later, but that would not result in any interruption caused by unloading in a critical range and only enable the constellation in that way. As another example of that, it is to be mentioned that an uncritical range of a cooking process can also be optimised/extended in order to move the critical range further backwards (after an interruption) in order to make a start of the cooking product combination possible. Furthermore, an unloading of the product by opening the door and thus an interruption can be delayed (after a critical range) in order to make a start of the cooking product combination possible. The optimised options or the options automatically determined by the cooking device for the prevention of interruptions for the start of the cooking product combination could first be indicated to the user before execution and offered to the user for confirmation.

### BRIEF DESCRIPTION OF THE DRAWINGS

Further details, advantages and characteristics of the disclosure in hand emerge from the description below of an exemplary embodiment based on the drawing.

FIG. 1 of the drawing shows a schematic, greatly simplified representation of a cooking device according to the disclosure,

FIG. 2 a schematic, greatly simplified cooking programme/cooking product selection,

FIG. 3 a schematic, greatly simplified allocation plan in the cooking chamber of a cooking device, and

FIG. 4 a graphic representation of a determination of an interruption of critical cooking states.

### DETAILED DESCRIPTION OF THE PREFERRED EMBODIMENT

Accordingly, the figure shows a cooking device 1 which features a housing 4 in which a cooking chamber 2 is arranged, which can be opened or closed by means of cooking chamber door 3 which can be opened and closed. As explained at the beginning, the cooking device 1 according to the disclosure naturally features all other required components, such as air duct, heater, cleaning device, etc., which do not have to be described in detail for the explanations of the principles of the disclosure in hand, however.

In the cooking chamber 2, a product carrier T can be arranged, on which a cooking product GP to be cooked can be arranged. Usually, a plurality of such carriers T are provided, which can be slid into the cooking chamber 2 on levels arranged one on top of the other, and which can receive cooking products or also a plurality of cooking products in each case.

As also explained at the beginning, the cooking product GP can have a critical cooking state kG which has to be observed in order to ensure the perfect cooking of the cooking product GP.

For that purpose, the cooking device 1 according to the disclosure optionally features a detection device 5, which may be a product scanner in the form of a camera or an otherwise suitable sensor, for example, in order to determine the type of cooking product GP introduced in the cooking chamber 2. The product scanner 5 is connected with a control device 6 by means of an operative connection/signal connection SL1 symbolised by a dashed line in order to make it possible with a particularly preferred embodiment to implement the method explained in the beginning, in particular fully automatically. Furthermore, the operator can naturally perform the input/selection of the cooking goods manually on the input device 8.

Furthermore, the cooking device 1 features an indicator device 7 and an input device 8.

Via a further operative connection or signal connection line SL2, the control device 6 is connected with an optional cooking chamber locking device 9, which features an extendible and retractable door lock 10. In the figure, this lock 10 is brought in the locking position due to the indication of the critical cooking state kG: 3 minutes because the indicator device 7 indicates the critical cooking state and an interruption of this critical cooking state kG has to be prevented accordingly. Accordingly, the lock 10 blocks the cooking chamber door 3 so that an arbitrary interruption of the critical cooking state kG can be prevented mechanically even in the event that the indication kG: 3 minutes on the indicator device 7 is disregarded.

When the critical cooking state kG ends, the lock 10 is retracted so that the cooking chamber door 3 can be released and opened accordingly in order to be able to unload the fully cooked cooking product GP from the cooking chamber 2.

As also explained at the beginning, further indications are naturally possible on the indicator device 7, such as a sequence of products which can be transferred in the cooking chamber 2 at the end of the critical cooking state kG.

In extreme situations, it is furthermore possible according to the disclosure to authorise an operator to override the blocking of a critical cooking state in these extreme situations, for example when an interruption of the critical cooking state is less detrimental than when a subsequent loading with further cooking products is prevented. Here, it can be provided that the cooking device outputs a warning for the operator, but that the operator still has the option of using the cooking device, for example in time-critical situations, by means of loading further cooking products.

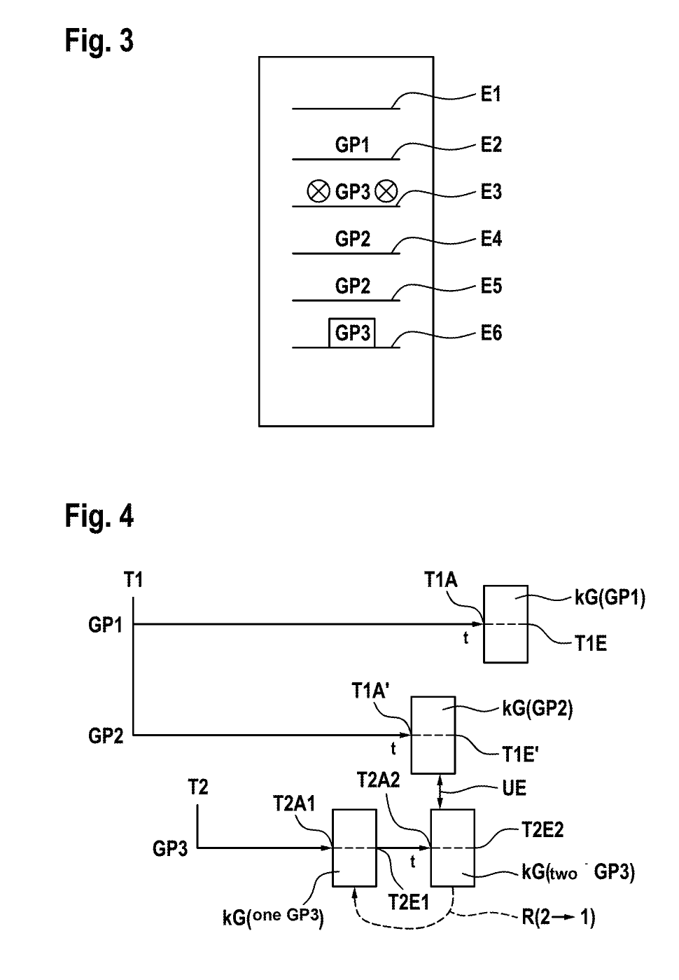

FIGS. 2 to 4 show, in a schematic, greatly simplified manner, in FIG. 2 a cooking programme/cooking product selection, in FIG. 3 an allocation plan and in FIG. 4 a graphic representation of the determination of interruptions of critical cooking states.

For that purpose, in a first process step in which no cooking product whatsoever is arranged in the cooking chamber of the cooking device, indicated merely as an example in FIG. 2, a selection of cooking products and cooking programmes, respectively, is carried out, which are to be introduced in the cooking chamber of a cooking device at a first time T1. In the exemplary case, a cooking product GP1 and two cooking products GP2 are selected for this loading at the time T1.

Furthermore, the allocation of the cooking chamber is entered or proposed according to the allocation plan 6 of FIG. 3 manually or automatically. In the exemplary case, the allocation plan shows 6 cooking goods levels E1 to E6 arranged one above the other. For the example explained here, it is proposed in the allocation plan or selected by the operator that the cooking product GP1 is assigned to cooking goods level E2, while the cooking products GP2 are assigned to cooking goods levels E4 and E5, respectively. It has to be emphasised that FIG. 3 only shows the allocation plan of the cooking chamber, i.e. the arrangement of the cooking products GP1 and GP2 shown in FIG. 3 on the levels E2, E4 and E5, respectively, does not represent a loading of the cooking chamber yet.

Instead, it is to be determined before this loading whether the cooking goods selection (GP1 once/GP2 twice) and the assignment in the allocation plan according to FIG. 3 are admissible by means of the determination of an interruption shown in FIG. 4.

For that purpose, it is determined when the critical cooking state kG of the cooking product GP1 starts (T1A) and when it ends (T1E) based on the scheduled loading time T1 on the timeline.

A suitable determination is carried out for the cooking products GP2, which is symbolised by the times T1A′ and T1E′. Here, FIG. 4 illustrates that there is no interruption of the critical cooking states kG (GP1) and kG (GP2) in the example selected. Accordingly, a loading is admissible, and the cooking products GP1 and GP2 can be arranged in the cooking chamber on the levels E2, E4 and E5.

Accordingly, the cooking process can also be started in the cooking device now.

Based on the example according to FIGS. 2 to 4, it is to be shown now how to proceed if a subsequent loading is carried out at a later time T2 (for example 5 minutes) after the loading at the time T1.

For this exemplary case, the selection of a further cooking product/cooking programme GP3 at the time T2 is assumed according to FIG. 2. According to the allocation plan of FIG. 3, it becomes clear that two cooking products GP3 are to be arranged in the cooking chamber at the time T2, for which purpose the allocation plan in this example determines the levels E3 and E6, or these are entered by the operator.

According to the determination of an interruption of FIG. 4, the critical cooking state kG for two cooking products GP3 to be loaded subsequently is determined now. This critical cooking state kG (two GP3) commences in the selected example at the time T2A2 and ends at the time T2E2. Here, the graphic representation of FIG. 4 illustrates that during loading of two cooking products GP3, there can/would be an interruption IN in the critical range of GP3 caused by the unloading of the product GP2 so that this loading is inadmissible. Furthermore, FIG. 4 assumes a reduction R (2→1) from two cooking products GP3 to one cooking product GP3 and consequently of the total duration of GP3. The critical cooking state kG (one GP3) would commence according to the example of FIG. 4 at the time T2A1 and end at the time T2E1, whereby the graphic representation of FIG. 4 illustrates that there will no longer be an interruption upon selection of only one cooking product GP3 so that the subsequent loading of a cooking product GP3 in the exemplary case is admissible on the cooking goods level E6, which is symbolised in FIG. 3 by the fact that the designation GP3 is indicated with a block on the level E6, while the cooking product GP3 on level E3 symbolises inadmissible loading by means of two circles with a cross.

The reason for the interruption IN explained in the event of the loading of two cooking products GP can be their quantity, size, the weight and the assigned cooking programme so that it would be possible, as is assumed in the selected exemplary case, to achieve a postponement of the assigned critical cooking state kG (one GP3) by reducing the number of cooking products to one cooking product GP3, which prevents an interruption and therefore constitutes an admissible loading.

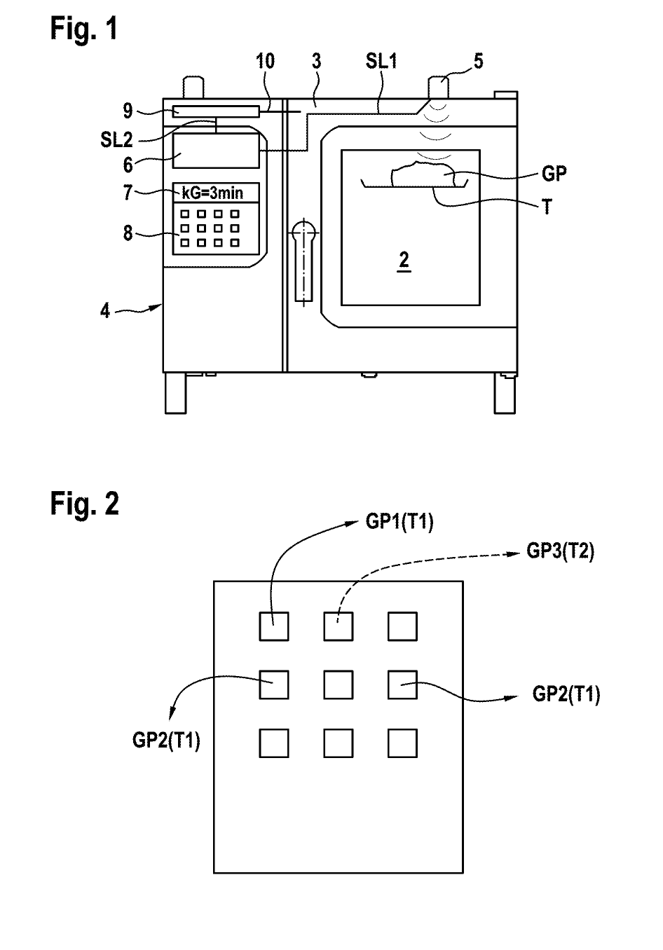

In addition to the written description above of the disclosure, reference is herewith made explicitly to the graphic representation of the disclosure in FIGS. 1 to 4 of the drawing for the purpose of its supplementary disclosure.

### LIST OF REFERENCE SIGNS

1 Cooking device
2 Cooking chamber
3 Cooking chamber door
4 Housing
5 Detection device (product scanner)
6 Control device
7 Indicator device
8 Input device
9 Locking device
10 Lock/cooking chamber lock
T Product carrier (tray)
GP Cooking product
kG Critical cooking state
SL1 Signal line
SL2 Signal line
IN Interruption
E1-E6 Cooking goods levels/levels
T1, T2 First and later second point of time of a loading

What is claimed is:

1. A method for cooking food products with matching cooking characteristics, which comprises the following process steps:
determining or entering of at least one critical cooking state of at least one said food product of the totality of the cooking products to be cooked;
starting of the cooking process of all food products;
indicating the attainment of the critical cooking state determined and/or entered and its duration; and
preventing an interruption of the critical cooking state, wherein
that a selection of new cooking processes is reserved and automatically recorded as a product waiting list at the end of the critical cooking state and its duration are indicated.

2. The method according to claim 1, wherein the indication is realised visually.

3. The method according to claim 1, wherein the indication is realised acoustically.

4. The method according to claim 1, wherein the preventing of the interruption of the critical cooking state is realised by blocking the access to the food products to be cooked.

5. The method according to claim 1, wherein the preventing of the critical cooking state is achieved by blocking the selection option on an indicator unit and/or input unit of the food products to be cooked.

6. The method according to claim 1, wherein the determining of the critical cooking state is carried out automatically and/or manually.

7. A method for cooking food products with matching cooking characteristics, which comprises the following process steps in the event of a first loading:
selecting of food products to be loaded in a cooking chamber of a cooking device,
determining the critical cooking states of the selected food products,
determining as to whether the critical cooking states, of the assigned food products are interrupted, and
enabling of the loading at a first time when no interruption is found.

8. A method for the cooking food products with matching cooking characteristics, which comprises the following process steps in the event of a subsequent loading:
determining as to whether there is already a loading of the cooking chamber with food products,
selecting of a least one further food product which could be loaded subsequently at a loading time which is later in comparison with the loading time,
determining as to whether there will be an interruption of the critical cooking state of the food products already inside the cooking chamber due to the critical cooking state of the further food product to be loaded subsequently, and
enabling of subsequent loading if no interruption is found.

9. The method according to claim 7, wherein the following parameters will be considered during the determining of the existence or non-existence of an interruption:
type of food products,
quantity of food products,
time period between the loading times,
food product space,
compensation values, such as door compensation and cooking time extension,
unloading times,
times of announcement steps with user interactions (door opening!), and
fan speed.

10. A cooking device for implementing the method according to claim 1,
with a cooking chamber which can be opened and closed by a cooking chamber door, and
by an indicator device for indicating the critical cooking state and its duration.

11. Cooking device according to claim 10, wherein the indicator device outputs a visual indicator signal.

12. Cooking device according to claim 10, wherein the indicator device outputs an acoustic indicator signal.

13. Cooking device according to claim 10, wherein the indicator device and/or an input device presents a limited food product selection option.

14. Cooking device according to claim 10, wherein the control device is in an operative connection with a cooking chamber locking device which blocks the opening of the cooking chamber door for the duration of the critical cooking state.

15. Cooking device according to claim 10, further comprising a product detection device for the detection of food products to be cooked, which is in an operative connection with a control device for the determination of a critical cooking state of at least one of the scanned products to be cooked.

16. A cooking device for implementing the method according to claim 7,
with a cooking chamber which can be opened and closed by a cooking chamber door, and
by an indicator device for indicating the critical cooking state and its duration.

17. A cooking device for implementing the method according to claim 8,
with a cooking chamber which can be opened and closed by a cooking chamber door, and
by an indicator device for indicating the critical cooking state and its duration.
